(19) United States
(12) Patent Application Publication
(10) Pub. No.: US 2007/0131468 A1
(43) Pub. Date: Jun. 14, 2007

(54) Motor vehicle provided with a pre-safe system

(75) Inventors: Wilfried Bullinger, Korntal-Muenchingen (DE); Michael Fehring, Neuhausen (DE); Florent Paviot, Trevoux (FR); Alfred Wagner, Gomaringen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/569,262

(22) PCT Filed: Aug. 6, 2004
(86) PCT No.: PCT/EP04/08862

§ 371 Date: Dec. 22, 2006

(30) Foreign Application Priority Data
Aug. 23, 2003 (DE) 103 38 760.9

(51) Int. Cl. B60K 28/14; E05F 15/00

(52) U.S. Cl. 180/282; 280/735; 701/45

(57) ABSTRACT

A motor vehicle is provided with a pre-safe system in which active and/or passive safety devices which are driven as a function of information recorded at least by a vehicle surrounding-area identification device and a driving situation data detection device. The information is evaluated in a data evaluation device which determines whether a collision is plausible. At least some of the active and/or passive safety devices are activated when the information from the vehicle surrounding-area identification device represents a potential collision object and the data from the driving situation data detection device represents a driver response which is predefined for a collision being plausible.

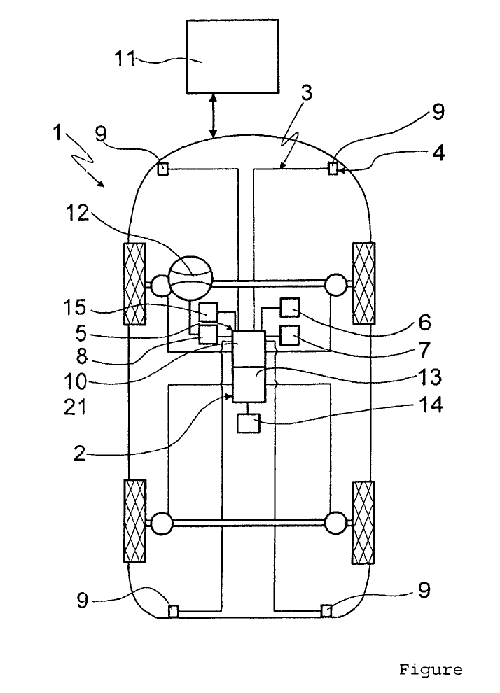

The invention relates to a motor vehicle with a pre-safe system of the type which is defined in more detail in the precharacterizing clause of patent claim 1.

Passenger vehicles and commercial vehicles of relatively recent types have active and passive safety devices which allow the driver to cope with his vehicle better even in critical situations and thus possibly to avoid a vehicle accident. Furthermore, safety devices such as these contribute to reducing the severity of the accident in the event of a crash.

Safety systems which have a preventative effect even before a possible crash and use a so-called pre-crash phase, that is to say a time period from identification of a high accident probability by means of appropriate detection systems in the vehicle to the actual impact, in order to extend the occupant protection by the use of additional safety measures and to reduce the severity of an accident, are referred to as pre-safe systems.

One significant component of a pre-safe system such as this is a vehicle surrounding-area identification sensor system, widely differing embodiments of which are known.

By way of example, EP 0 952 459 A2 describes an apparatus for object detection for motor vehicles, which has a distance sensor system formed by a large number of distance sensors, with the distance sensors being arranged on the motor vehicle in such a way that they scan the area surrounding the motor vehicle. Furthermore, an evaluation unit is provided which uses the data from the distance sensor system to determine the movement path and the speed of an object relative to the motor vehicle, in which case the distance sensors can be driven selectively by the evaluation unit and the range and/or the measurement repetition frequency and/or the resolution and/or the operating mode of the distance sensors can be varied. This apparatus can simultaneously or successively provide data for various driver assistance apparatuses, and can be used as a pre-crash sensor system.

DE 197 29 960 A1 describes a method for impact identification, particularly in the case of motor vehicles for activation of occupant protection devices, with at least one pre-crash sensor being provided which registers the change in the relative speed and/or the relative distance to objects within a predetermined near area surrounding the vehicle. If the change in the relative speed detected by the pre-crash sensor exceeds at least one predetermined threshold value and/or the relative distance falls below a predetermined threshold value, this is identified as a safety-critical state, and the initiation threshold is reduced.

A further method for impact identification for a motor vehicle is known from DE 101 00 880 A1, in which case radar sensors are provided as pre-crash sensors, by means of whose signals an effective mass is determined for an impact object. The effective mass is compared with predetermined threshold values for classification of the impact object, with the classification then governing the use of restraint means.

A further method for initiation of restraint means in a motor vehicle in the event of an impact or a collision with an object is described in DE 100 65 518 A1. For the purposes of this known method, the time profile of the acceleration is detected in the form of at least one acceleration signal, and the time profile of a speed is generated from the acceleration signal. The initiation of the restraint means is matched to the specific impact situation by using a pre-crash sensor system to determine the impact speed and the impact time even before the impact by the impact situation being classified on the basis of the impact speed, by the classification of the impact situation being used to determine an initiation time window in which the time profile of the speed is generated, and by a threshold value for the speed being determined in parallel with this from the acceleration signal, taking into account the classification of the impact situation. If the pre-crash sensor system has at least two pre-crash sensors which are arranged in a suitable manner, then, in addition, it is also possible to use a triangulation method to determine the offset, that is to say the impact point and the impact angle. In this case, for example, radar measurements, infrared measurements or else optical measurement methods may be used for pre-crash sensing purposes.

One example of a pre-crash sensing system with an image detection device for optimal detection of objects at a distance is disclosed in DE 198 42 827 A1.

However, all of the known types of vehicle surrounding-area identification devices share the disadvantage that, depending on the technology and the system design, they identify an object which is only apparently present more or less frequently, and thus initiate a “false alarm” which can result in undesirable activation of numerous active and passive safety systems, such as reversible belt tighteners, movable bumpers, variable-hardness impact elements and a drive (which is intended for a crash situation) for level regulation or for the braking and steering system.

On the other hand, in the case of the known vehicle surrounding-area identification devices, which are highly susceptible to faults, an actual object which is relevant for a crash may possibly not be identified, so that the occupant protection systems are initiated too late and possibly not until after the impact itself, so that no time remains for optimum conditioning of vehicle restraint systems and occupants for the imminent accident.

One example for activating a reversible occupant protection means in a motor vehicle with a pre-safe system is disclosed in DE 101 21 386 C1. In this case, the driving state data is monitored for an emergency braking state, and the occupant protection system is actuated if an emergency braking state is determined. In addition, a data processing device determines an oversteering and an understeering state. When the data processing device determines the emergency braking state and/or the oversteering state and/or the understeering state, the reversible occupant protection system is actuated.

However, this solution has the disadvantage that only data from within the vehicle can be processed by the use of sensor systems which are already present in the vehicle without the additional use of surrounding-area data. It is thus not possible to initiate the occupant protection means as a function of the type of impact situation and the collision object.

One object of the present invention is therefore to provide a motor vehicle with a pre-safe system of the type mentioned initially which uses the advantages of a vehicle surrounding-area identification device and in which the false-alarm rate of the pre-safe system with unnecessary activation of early-initiating occupant protection systems is reduced.

In the case of a motor vehicle with a pre-safe system of the type mentioned in the precharacterizing clause of patent claim 1, this object is achieved according to the invention in that at least some of the active and/or passive safety devices are activated when the information from the vehicle surrounding-area identification device represents a potential collision object and the data from a driving situation data detection device represents a driver response which is predefined for a collision being plausible.

In consequence, with the solution according to the invention, the signals from the sensor system for the vehicle surrounding-area identification device are linked to specific features which describe the driver response, and are used for initiation of the active and/or passive safety devices in the motor vehicle only when a driver response appropriate to this also occurs when a collision object is present. The number of spurious initiations can advantageously be drastically reduced by using the driver reaction that normally takes place when he himself identifies the collision object to check for plausibility of the knowledge obtained by the vehicle surrounding-area identification device.

The data which represents a driver response to collision object identification by the driver himself includes the accelerator pedal position and/or an accelerator pedal movement, the brake pedal position and/or a brake pedal movement, a steering movement, oversteering or understeering of the vehicle with respect to the steering angle or physiological data which makes it possible to deduce a panic reaction, and thus identification of a potential collision object, by the driver. Threshold values and combinations can be predetermined for all of these variables, which must be exceeded or satisfied in order to confirm the plausibility of a collision object identified by the vehicle surrounding-area identification device.

Thus, in one advantageous embodiment of the invention, the data evaluation device can emit a collision plausibility when the brake pedal is operated at a brake pedal speed which is greater than a predefined threshold value, as is the case, for example, during so-called emergency braking.

Furthermore, the data evaluation device can deduce that the driver has identified a collision object when the accelerator pedal is moved to a minimum position or to idle or to a maximum position or full power at a speed which exceeds a predefined speed threshold, and the brake pedal is operated within a predetermined period, preferably of a few hundred milliseconds, after the foot has been moved off the accelerator pedal.

Collision object identification by the driver can also be assumed when a limit value (which is related to the speed of the motor vehicle itself) is calculated for a steering wheel speed and/or a steering wheel acceleration, and one of the two variables, or both variables together, exceed(s) the corresponding limit value for a specific time. In this case, a manipulated variable can be determined from the steering wheel speed or the steering wheel acceleration, or from both variables together, and the plausibility of collision object identification can be assumed from the driver reaction when the manipulated variable exceeds an adjustable value.

In one advantageous embodiment of the invention, it is also possible to provide for the data evaluation device to emit a collision plausibility when a control activity on a control element exceeds a predefined time period. In empirical investigations, it has been found that, when control elements, for example for a radio or some other entertainment device, for an air-conditioning system, for a telecommunications device or for some other system or switch, are operated by the driver, he is briefly distracted from the driving task, and this is a reason for an increased accident probability. In the case of a control activity which can be identified, for example, via a CAN bus and which exceeds a specific, adjustable time, plausibility of a collision object identification by the vehicle surrounding-area identification device can therefore be assumed.

In a further embodiment of a motor vehicle designed according to the invention, the data evaluation device can also emit a collision plausibility when physiological data relating to the driver matches predetermined physiological data which represents collision object identification by the driver. In the event of a so-called panic reaction, which occurs when the driver identifies an immediately imminent prospect of an accident, numerous physiological data items for the driver change significantly, including, for example, data which can be measured easily, such as the heart rate and the perspiration behavior. Determination of a panic reaction such as this, for example by a measurable increase in the pulse rate of the driver, by means of sensors which are integrated in the steering wheel and of the type which is also known, for example, from sporting equipment, provides infallible plausibility verification for the actual presence of a collision object which has been determined by the vehicle surrounding-area identification device.

In the case of a motor vehicle according to the invention, a fundamental plausibility of all collision objects determined by the vehicle surrounding-area identification device can be confirmed by the driver reaction, that is to say protection measures are activated only when the data situation with regard to the vehicle surrounding-area identification device indicates that an object is approaching, on the basis of the relative speed and distance, and a driver reaction has occurred.

In order fundamentally not to exclude all collisions in which there is no driver reaction, in one advantageous embodiment of the invention it is also possible to provide for the data evaluation device to emit a collision plausibility when the speed of the collision object itself is greater than the predetermined limit value with respect to the speed of the motor vehicle itself. The link to the driver activity is thus valid only in the case of collision objects which are not moving themselves or are moving only at a slow speed themselves within the predetermined range, for example ±1 km/h. This range is governed by the measurement accuracy of the speed measurements of the surrounding-area sensor system, with the speed of the motor vehicle itself being a reference variable.

An embodiment such as this of the motor vehicle according to the invention means that, for example, a vehicle-vehicle collision in which two vehicles are involved is identified as a relevant collision and the suitable safety measures are activated.

The safety devices which can be activated include, for example, conventional restraint means such as an airbag and a safety belt with a belt tightener as well as movable impact bodies, cushions and headrests, whose size, hardness, shape and position can be varied by means of a drive. Furthermore, devices which move the occupant to a good position for the accident, such as electric seat adjustment, headrest adjustment, a safety belt tightener and movable cushions, can be activated.

In addition, protection means which are used to protect others involved in a collision, such as pedestrians and cyclists, can also be activated, such as an adjustable engine hood, movable bumpers and variable hardness impact elements on the outer surface of the vehicle. Appropriate actions can also be provided for the level control and the braking and steering system.

Further advantages and advantageous refinements of a motor vehicle according to the invention can be found in the description, in the drawing and in the patent claims.

The single FIGURE of the drawing shows, in an outline form, one exemplary embodiment of a motor vehicle equipped according to the invention, which will be described in more detail in the following description.

The drawing FIGURE shows a schematic plan view of a motor vehicle 1 which may be a passenger vehicle or a commercial vehicle, with major components of a pre-safe system 2 according to the invention.

One major component of the pre-safe system 2 is a safety sensor system 3 which has a vehicle surrounding-area identification device 4 and a driving situation data detection device 5 with a driving state sensor system 6, an impact sensor system 7 and an interior sensor system 8. The safety sensor system 3 for the vehicle 1 is in the present case used at different levels depending on the level of danger to the motor vehicle 1. The components of the safety sensor system 3 may in this case be designed in a known manner, for example being of a type as described in the patent documents cited initially.

Thus, in the present case, the vehicle surrounding-area identification device 4 represents a 24-GHz radar near-field sensor system which is known per se and has a range of approximately 20 m to 30 m, and a tracking range of about 6 m, with a plurality of distance sensors 9, the number of which is chosen so as to completely cover the area all round the vehicle 1.

The signals from the distance sensors 9 are processed, in the same way as the signals from the other sensor systems as well, in a data evaluation device 10, with the signals from the distance sensors 9 being processed in order to provide information about distances and relative speeds with respect to a possible collision obstruction 11, which may be another motor vehicle, a stationary obstruction or a pedestrian, and about a possible impact angle.

The distance sensors 9 transmit highly focused electromagnetic waves in the form of short pulses. When they strike an object, these waves are reflected and the distance between the motor vehicle 1 as the transmission point and the obstruction 11 as the echo point can be determined by measuring the delay time of the pulse between these two objects. The speed of the object 11 relative to the motor vehicle 7 can thus also be measured with the assistance of the Doppler effect.

Other known systems may, of course, also be used for the design of the vehicle surrounding-area identification device.

Even during normal operation, the driving state sensor system 6 analyzes important driving-dynamic variables, such as the vehicle speed, the wheel rotation speeds, the vehicle longitudinal acceleration and vehicle lateral acceleration, the yaw rate, the suspension inward and outward deflection movement, the vehicle level as well as variables which are particularly important for the present pre-safe system 2, such as the accelerator pedal position, the accelerator pedal movement, the brake pedal position and the brake pedal movement, as well as the steering wheel speed and the steering wheel acceleration. In this case, actual values of these variables are compared with predetermined nominal values and threshold values. Driving dynamic systems, such as an antilock braking system and an electronic stability program, are activated on the basis of these comparisons, with the object of helping the driver to avoid an accident in critical driving situations.

When an impact is expected, the impact sensor system 7 identifies this within a few milliseconds and passes on information about the severity of the accident to the data evaluation device 10. Acceleration sensors, pressure sensors, intrusion sensors and contact sensors are used in a known manner for this purpose, and are used to control, for example, pyrotechnic restraint systems.

The vehicle situation data detection device 5 is complemented by the interior sensor system 8 which, in the present case, provides information about the status of the occupants, the occupant position and the available restraint systems as well as physiological data about the driver. In the present case, appropriate sensors are incorporated in the steering wheel 12 of the motor vehicle 1 in order to detect the pulse rate and thus in order to identify a panic reaction by the driver in the event of collision object identification.

Depending on the data evaluation by the data evaluation device 10, signals are emitted to active safety devices, in this case for example, to a control or an active chassis control system 13, and to passive safety devices, for example to an airbag controller 14.

In further embodiments, it is, of course, also possible to act on an electronic stability program or on further active and/or passive safety devices.

All of the active and passive safety devices 13, 14, or individual ones of them, are activated when the information from the vehicle surrounding-area identification device 4 represents a potential collision object 11, and data from the driving situation data detection device 5 represents a driver response which is predefined for checking collision plausibility. The data evaluation device 10 thus in the present case emits a collision plausibility when, in addition to the identification of the collision object 11 by means of the vehicle surrounding-area identification device 4, the driving state sensor system 6 detects that the brake pedal is being operated at a brake pedal speed greater than a predefined threshold value, or that the accelerator pedal is being moved at an accelerator pedal speed which is greater than a predefined threshold value, and finds that the brake pedal has been operated within a predefined time after the foot has been removed from the accelerator pedal.

In the same way, the data evaluation device 10 in the present case emits a collision plausibility when the steering wheel speed or the steering wheel acceleration exceeds a limit value for a predefined time or the sensors on the steering wheel 12 identify a sudden increase in the pulse rate, and thus a panic reaction by the driver.

Furthermore, the data evaluation unit 10 is fed with the control times for a control element 15, which in this case is indicated only by way of example, so that the data evaluation device 10 also emits a collision plausibility when a control activity of the control element 15 exceeds a predefined time on identification of the collision object 11 by the vehicle surrounding-area identification device 4.

1-9. (canceled)

10. A motor vehicle with a pre-safe system, comprising:
a vehicle surrounding-area identification device;
a driving situation data detection device;
at least one of active and passive safety devices which are driven as a function of data obtained by the vehicle surrounding-area identification device; and
a data evaluation device which evaluates data received from the vehicle surrounding-area identification device and the driving situation data detection device,
wherein at least some of the at least one active and passive safety devices are activated when the data evaluation device determines that
data from the vehicle surrounding-area identification device represents a potential collision object, and
data from the driving situation data detection device represents a driver response which is predefined as indicating that a collision is plausible and represents a reaction of the driver to identification of the collision object.

11. The motor vehicle as claimed in claim 10, wherein
the data which represents a driver response to a collision being plausible comprises at least one of an accelerator pedal position and an accelerator pedal movement.

12. The motor vehicle as claimed in claim 10, wherein
the data which represents a driver response to a collision being plausible comprises at least one of a brake pedal position and a brake pedal movement.

13. The motor vehicle as claimed in claim 12, wherein
the data evaluation device determines a collision is plausible when the brake pedal is operated at a brake pedal speed which is greater than a predefined threshold value.

14. The motor vehicle as claimed in claim 11, wherein
the data evaluation device determines a collision is plausible when the accelerator pedal is moved at an accelerator pedal speed which is greater than a predefined threshold value and the brake pedal is operated within a predefined time period after the foot has been moved off the accelerator pedal.

15. The motor vehicle as claimed in claim 12, wherein
the data evaluation device determines a collision is plausible when the accelerator pedal is moved at an accelerator pedal speed which is greater than a predefined threshold value and the brake pedal is operated within a predefined time period after the foot has been moved off the accelerator pedal.

16. The motor vehicle as claimed in claim 13, wherein
the data evaluation device determines a collision is plausible when the accelerator pedal is moved at an accelerator pedal speed which is greater than a predefined threshold value and the brake pedal is operated within a predefined time period after the foot has been moved off the accelerator pedal.

17. The motor vehicle as claimed in claim 10, wherein
the data evaluation device determined a collision is plausible when a limit value for at least one of a steering wheel speed and a steering wheel acceleration is greater than a predetermined limit for a predefined time period, where the predetermined limit varies as a function of the speed of the motor vehicle.

18. The motor vehicle as claimed in claim 10, further comprising:
a control element,
wherein the data evaluation device determines a collision is plausible when a control activity of the control element exceeds a predetermined time period.

19. The motor vehicle as claimed in claim 10, wherein
the data evaluation device determines a collision is plausible when physiological data relating to a driver matches predetermined physiological data which represents collision object identification by the driver.

20. The motor vehicle as claimed in claim 10, wherein
the data evaluation device determines a collision is plausible when a speed of the collision object relative to the motor vehicle is greater than a predetermined limit value.
